(19) United States
(12) Patent Application Publication
(10) Pub. No.: US 2008/0284294 A1
(43) Pub. Date: Nov. 20, 2008

(54) Piece of Furniture

(75) Inventors: Michael Leidner, Atlanta, GA (US); Volker Pohlmann, Herford (DE); Detlev Kruse, Spenge (DE); Stefan Salomon, Bielefeld (DE)

Correspondence Address: BARNES & THORNBURG LLP, 750-17TH STREET NW, SUITE 900, WASHINGTON, DC, 20006-4675, US

(73) Assignee: PAUL HETTICH GMBH & CO. KG, Kirchlengern (DE)

(21) Appl. No.: 11/750,615

(22) Filed: May 18, 2007

(51) Int. Cl. E05C 7/06

(52) U.S. Cl. 312/221

(57) ABSTRACT

A piece of furniture comprises several sliding elements arranged above one another. Each sliding element is arranged behind a swivellable flap and may be pulled out of a furniture cabinet only when the flap is open. The sliding elements are associated with a blocking rail that is arranged on the furniture cabinet. The blocking rail may be moved by way of a lock between an unlocked and a locked position. The blocking rail is coupled with locking elements, by means of which flaps may be locked. As a result, a protection against tilting and a locking of the flaps can be implemented by way of the blocking rail.

### CROSS-REFERENCE TO RELATED APPLICATIONS

This application is a first-filed application and does not rely on any other application for priority.

1. Field of the Invention

The present invention relates to a piece of furniture having several sliding elements arranged above one another, each sliding element being arranged behind a swivellable flap. More specifically, the present invention relates to a piece of furniture where the sliding elements may be pulled out of a furniture cabinet only after the flap is opened. Even more specifically, the present invention relates to a piece of furniture where a blocking rail for the sliding elements is arranged on the furniture cabinet. The blocking rail may be moved by way of a lock between a locked and an unlocked position.

2. Related Art

From European Patent Document EP 377 703, an armature for several drawers arranged above one another is known. In the disclosure, the armature protects against tilting of the piece of furniture by providing a displaceable, lateral, blocking rail in the furniture cabinet. When a drawer is pulled out of the furniture cabinet, a pin engages in a groove at the blocking rail and moves the latter such that, as a result of the movement of the blocking rail, the other drawers cannot be pulled out. This ensures that only one drawer may be pulled out at any given moment, thereby avoiding tilting of the piece of furniture as a result of the weight of several pulled-out drawers being pulled out at the same time.

In U.S. Pat. No. 7,140,700, a locking system for drawers is described. Here, the blocking rail has several blocking elements which may be displaced by a predetermined path. When a drawer is pulled out, the blocking elements are displaced and, as a result of stops, cannot be moved farther apart. Like the previous example, this operation ensures that only one drawer may be pulled out of a piece of furniture at any given time.

There are applications known in which the drawers are to be arranged in a covered manner behind swivelable flaps. Not only do the flaps guarantee an attractive appearance, they also permit locking when it is desired to limit access to the contents of the drawers or to avoid unauthorized opening of the flaps.

European Patent Document EP 600 719 shows a piece of furniture having a swivelable flap, which can first be swiveled away from the front of the drawer and then be slid into a furniture cabinet. Such flaps are particularly suitable for furniture where open sliding elements are present in the furniture cabinet.

While furniture of this general type is known, there remains a need for furniture that includes a swivellable flap in front of a pull-out drawer that includes features such as security (i.e., locking of the furniture) and an anti-tilt feature (i.e., permitting no more than one drawer to be pulled out from the furniture at any given time.

### SUMMARY OF THE INVENTION

Accordingly, it is an aspect of the present invention to provide a piece of furniture where the sliding elements can easily be arranged in a secured manner behind a closable flap.

It is, therefore, one aspect of the present invention to provide a piece of furniture with a cabinet, a plurality of sliding elements arranged above one another in the cabinet, and a plurality of swivellable flaps being positioned in front of the plurality of sliding elements. The piece of furniture also includes at least one blocking rail disposed within the cabinet, a plurality of locking elements associated with the at least one blocking rail, and a lock operably connected to the at least one blocking rail to lift and lower the at least one blocking rail, thereby lifting and lowering the plurality of locking elements. Each of the plurality of sliding elements are constructed and arranged to be pulled out of the cabinet only after an associated swivellable flap is opened. Moreover, the lock is constructed and arranged to operate on the at least one blocking rail and the plurality of locking elements to cause the plurality of locking elements to engage the plurality of swivellable flaps, thereby establishing a locked position, and to disengage from the plurality of swivellable flaps, thereby establishing an unlocked position.

It is another aspect of the present invention to provide a piece of furniture with a blocking rail for sliding elements, where the sliding elements are coupled with locking elements by means of which one flap respectively can be locked. As a result, by means of the blocking rail and the locking elements, a protection against tilting, which prevents that several sliding elements are pulled out simultaneously, as well as a simple locking for the flaps on the furniture cabinet can be implemented. This multiple function of the blocking rail permits a simple structure and a compact construction.

As should be appreciated by those skilled in the art, a piece of furniture consistent with the present invention is particularly suitable for an office environment, where open sliding elements are used for storing objects, such as files. These are then arranged in a covered fashion behind the swivelable flaps, in which case, if required, a simple locking of the flaps may be effectuated.

According to one embodiment of the invention, the blocking rails lock the swivelable flap as well as the displaceable sliding elements in a locked position by means of the locking elements. This produces a double safety effect, because a pulling-out of the sliding elements is prevented by way of the blocking rail even if the flaps are removed.

In an unlocked position, the blocking rail with the locking elements permits an opening of the flaps and ensures that, when a sliding element is pulled out, a pulling-out of additional sliding elements is blocked. This ensures a protection against tilting, which is particularly important in the case of sliding elements which have a considerable weight as a result of the objects stored thereon.

In order to avoid a one-sided loading of the sliding element, a blocking rail with locking elements is preferably provided on opposite sides of each sliding element, so that there will be no inclination of a flap or a sliding element during a locking.

Each blocking rail preferably has a movable rail with blocking elements displaceably disposed on or in the rail. The blocking elements may be displaceable by a predetermined path between two stops and, during the opening of a sliding element, may arrange a spacer between two adjacent blocking elements, in which case, a pushing-apart of the blocking element by another spacer of a sliding element is prevented by the two stops. This ensures, by means of simple mechanical devices, that only one sliding element may be slid out of the furniture cabinet at any given time.

For the moving of a locking element, the latter may be equipped with a driving device which is coupled with a blocking element. As a result, when the rail and/or a blocking element is/are lifted, the locking element can also be moved. For a locking of the flaps, a hook is shaped onto each locking element, which hook can be moved such that, for locking a flap, it can reach behind a web or a wall section of the flap. Other locking devices also can be used.

If each locking element is constructed to be symmetrical with respect to a center plane, the locking elements can be used on the right as well as on the left side of a furniture cabinet. This facilitates storage of the locking elements prior to assembly into the piece of furniture.

For an easy mounting, the blocking rail can be disposed on a holding rail connected with the furniture cabinet. In this case, the blocking rail can also be movably held in the holding rail. The unit can therefore easily be assembled from the holding rail, the blocking rail and blocking elements.

The blocking rail is preferably connected with a lock by way of a yoke, which lock can move the blocking rail from a lowered unlocked position into a lifted locked position. The yoke can be connected with the rail in which the blocking elements are disposed, so that a locking of the sliding elements and the flaps is achieved by means of the lock.

Other aspects of the present invention will be appreciated by those skilled in the art from the description provided herein.

### BRIEF DESCRIPTION OF THE DRAWINGS

In the following, the invention will be explained in detail by means of one or more embodiments with respect to the attached drawings, in which:

FIG. 1 is a partial, elevational, side view of a piece of furniture according to the invention, showing a portion of a side wall;

FIG. 2 is an enlarged view of a detail of the side wall illustrated in FIG. 1;

FIG. 3 is a perspective view of a piece of furniture according to the invention, with the sliding elements removed;

FIG. 4 is an enlarged view of a detail of the piece of furniture illustrated in FIG. 3;

FIG. 5 is an enlarged view of a detail of the piece of furniture illustrated in FIG. 3;

FIG. 6 is a perspective view of the piece of furniture illustrated in FIG. 3, showing the flap half opened;

FIG. 7 is an enlarged view of a detail of one locking element;

FIG. 8 is a perspective view of the piece of furniture illustrated in FIG. 3, showing a flap in the closed position and showing the piece of furniture in a locked condition;

FIG. 9 is an enlarged view of a detail of the piece of furniture illustrated in FIG. 8, showing the area of the lock;

FIG. 10 is an enlarged view of a detail of the piece of furniture illustrated in FIG. 8, showing the area of the locking element;

FIGS. 11A and 11B are two perspective views of the locking element, the views being from the front and rear sides of the locking element;

FIG. 12 is a perspective view of a detail of a locking element according to a another embodiment;

FIG. 13 is a perspective view of the locking element illustrated in FIG. 12, shown in the locked position; and

FIGS. 14A and 14B are two perspective views of the locking element illustrated in FIG. 12, the views being from the front and rear sides of the locking element.

### DESCRIPTION OF EMBODIMENT(S) OF THE INVENTION

While the discussion that follows specifically addresses one or more contemplated embodiments of the present invention, it is intended that the scope of the invention encompass equivalents thereto and variations thereon, as would be appreciated by those skilled in the art. In other words, it is not intended for the scope of the invention to encompass only the embodiments described.

A piece of furniture 1 comprises a cabinet-shaped furniture cabinet 2 on whose opposed side walls pull-out guides 3 are mounted. Sliding elements are fastened to the pull-out guides 3. The sliding elements may be constructed as standard drawers, drawers for receiving suspended pocket files, sliding shelves, or other sliding elements, as would be appreciated by those skilled in the art. Each sliding element includes a front panel or grip element 40 that permits a user to slide the sliding element out of the furniture cabinet 2 or push the sliding element into the furniture cabinet 2. In one contemplated embodiment of the furniture cabinet 2, several sliding elements on several respective pull-out guides 3 are distributed over the height of the piece of furniture 1.

In one contemplated embodiment, a swivellable flap 4 is provided for each sliding element 3. Of course, more than one swivellable flap 4 may be employed without departing from the present invention. For each swivellable flap 4, one receiving device 5 is provided between adjacent ones of the sliding elements 3, as required for the particular piece of furniture 1. After the swivellable flap 4 is pivoted into a horizontal position, the swivellable flap 4 may be pushed into the receiving device 5. The swivellable flap 4 may be constructed as disclosed in European Patent Document EP 600 719. Such flaps are also called “flipper doors”. As should be appreciated by those skilled in the art, the swivellable flap 4 may be constructed according to any other suitable alternative design without departing from the scope of the present invention.

Each sliding element 3 is coupled to a self-retraction device 6. The self-retraction device 6 biases and holds the sliding elements in a closed position as a result of a predetermined spring force applied to the sliding element 3. The self-retraction device 6 is tensioned when a sliding element 3 is pulled out. A blocking rail is activated simultaneously when the sliding element 3 is pulled out. The blocking rail comprises a rail 8 in which one or more movable blocking elements 9 are disposed. Preferably, the rail 8 includes two or more blocking elements 9.

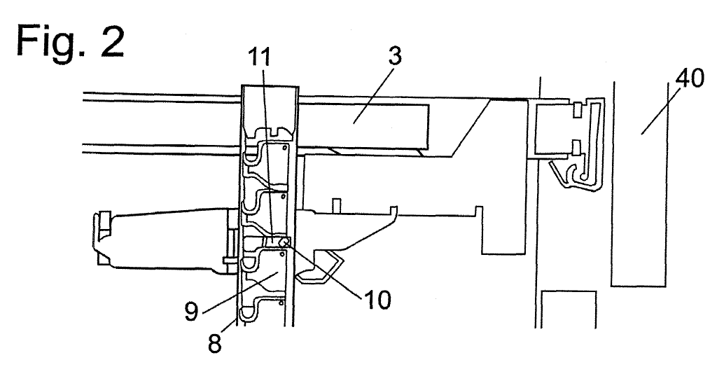

As illustrated in the enlarged representation of FIG. 2, during the opening of a sliding element 3, a spacer 10, which is disposed on the self-retraction device 6, is inserted between two blocking elements 9 so that a gap 11 is formed between two neighboring ones of the blocking elements 9. The blocking elements 9 are disposed within the rail 8 such that they are displaceable only along a predetermined path between the stops 41 and 42. When a spacer 10 engages between two blocking elements 9, the blocking elements 9 are packed within the rail 8 such that the blocking elements 9 cannot be pushed further apart or, if they can be pushed further apart, only by a slight distance. In this fashion, a second spacer 10 is prevented from being inserted between two additional blocking elements 9 at the same time as the first spacer 10. This ensures that only one sliding element 3 can be pulled out of the furniture cabinet 2 at any given time. Particularly in the case of sliding elements 3 which receive higher weight loads, a protection against tilting is provided in this manner.

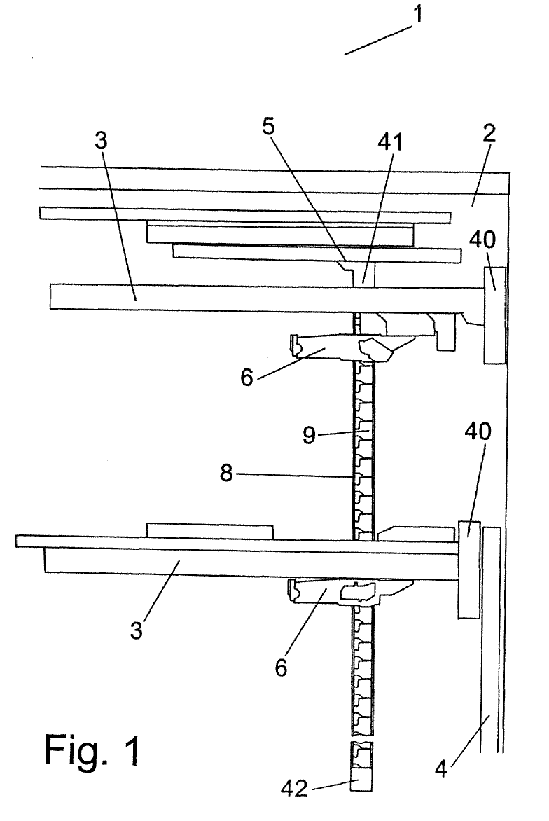

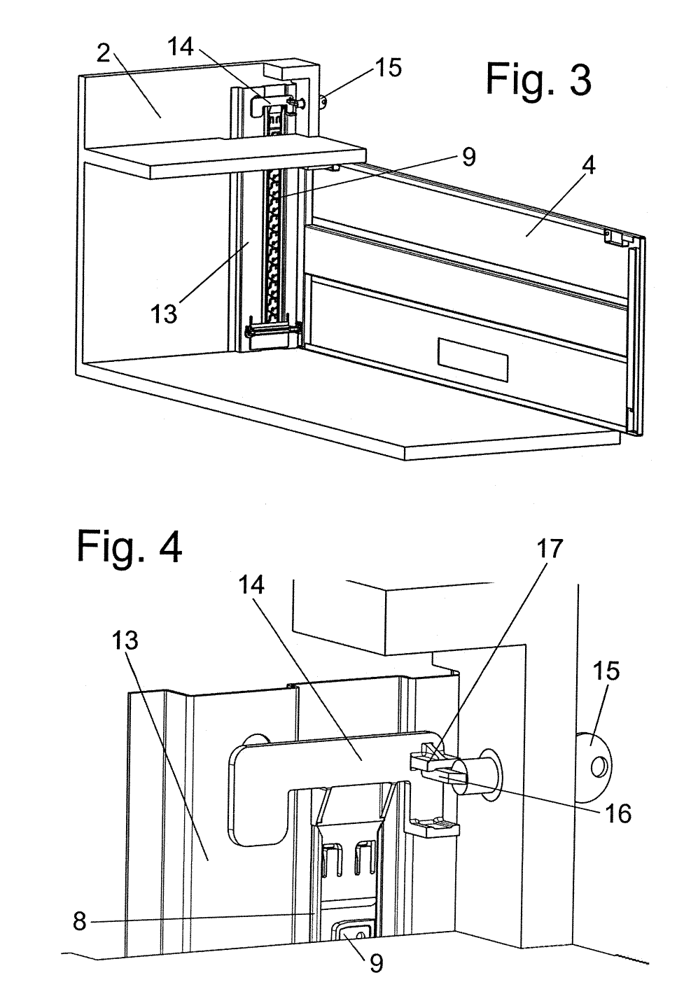

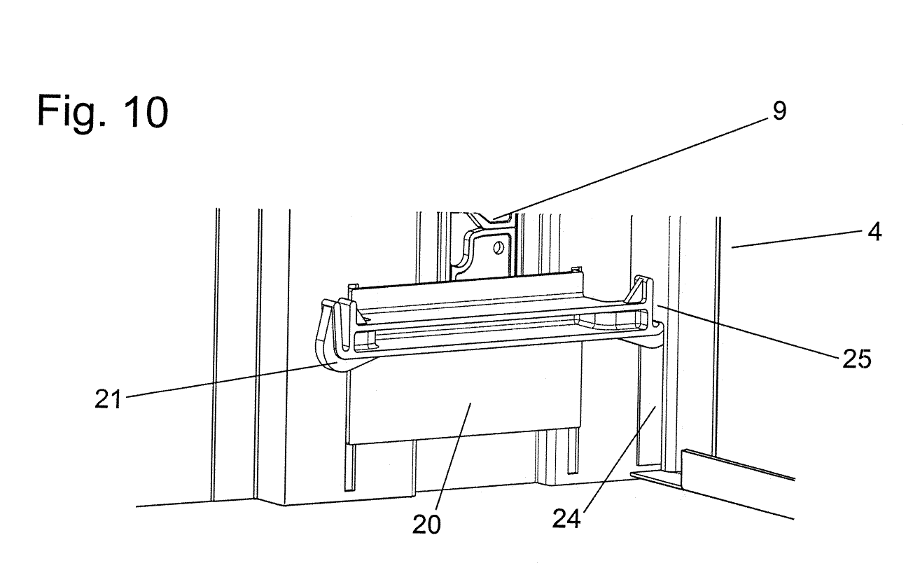

FIGS. 3 to 10 provide schematic representations of the piece of furniture 1 that is illustrated in FIG. 1. As is apparent, the sliding elements and pull-out guides 3 are omitted to facilitate discussion of the aspects illustrated in these figures.

The furniture cabinet 2 is closed by means of one or more swivellable flaps 4, behind each of which a sliding element 3 is arranged in a covered manner. On opposite sides of each sliding element 3, a blocking rail is provided which is formed by a rail 8 and blocking elements 9 disposed therein. The rail 8 is displaceably disposed on a holding rail 13, the holding rail 13 being fixed to the furniture cabinet 2.

As illustrated in FIG. 4, a yoke 14 is disposed on the holding rail 13 above the rail 8. While illustrated in a horizontal arrangement in the figures, the yoke 14 may be displaced in the vertical direction without departing from the contemplated scope of the present invention. Protruding projections 17 are constructed on the yoke 14. A bar 16 of a lock extends between the projections 17. The lock can be rotated by way of a key 15. In FIG. 4, the lock is illustrated in the unlocked position. As a result, the yoke 14, as well as the rail 8 and the blocking elements 9, also are illustrated in the lowered, unlocked position.

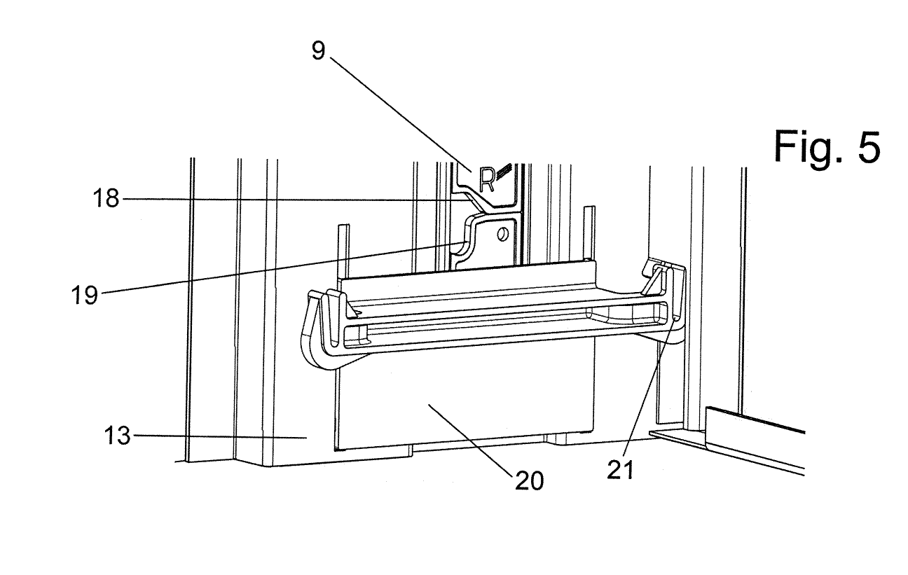

FIG. 5 illustrates an area of the blocking rail in which a locking element 20 is arranged. The locking element 20 comprises lateral hooks 21, which are used for locking the swivellable flap 4. The locking element 20 is disposed on the holding rail 13 and may be moved in the vertical direction together with the rail 8. FIG. 5 also shows the plate-shaped blocking elements 9. In the illustrated embodiment, the blocking elements 9 each include a stop slope 18 in the lower area, which interacts with the spacers 10. When a spacer 10 impacts on the stop slope 18, the blocking elements 9 situated above it are displaced in the upward direction. The displaced blocking elements 9 are then in such a position that spacers 10 situated above them cannot be further displaced as a result of the stops 41 and 42. This ensures that only one spacer 10 may be inserted between blocking elements 9 at any given time. In the upper area, the blocking elements 9 each additionally include a receiving device 19 on which a driving device of the locking element 20 is disposed. As a result, the locking element 10 can be displaced upwards when the blocking elements 9 are moved.

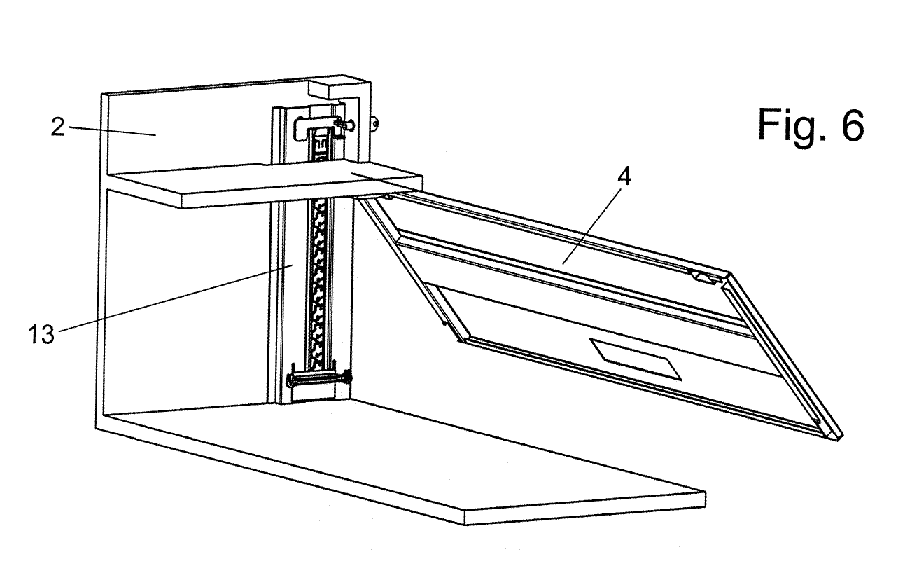

FIG. 6 shows the piece of furniture 1 with a partially-opened flap 4. The flap 4 first may be swiveled upwards and then, once in a horizontal position, may be slid into a receiving device 5 within the furniture cabinet 2.

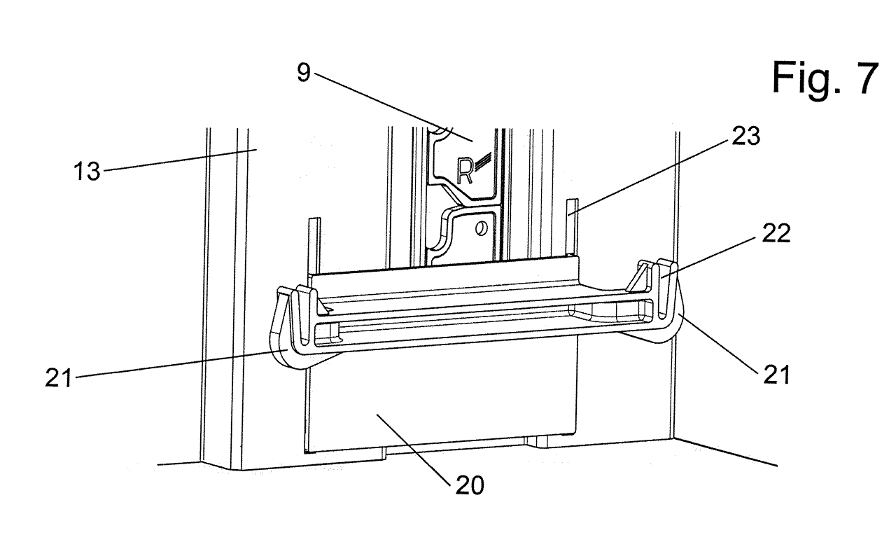

FIG. 7 shows the area of the locking element 20 in which the flap 4 is opened and the locking element 20 is in an unlocked, lowered position. Each end of the locking element 20 defines a hook 21, respectively. Each hook 21 defines a slot 22 into which a web or a wall section of the flap 4 may be inserted. The locking element 20 is displaceably disposed on the holding rail 13 in a ledge-shaped recess 23.

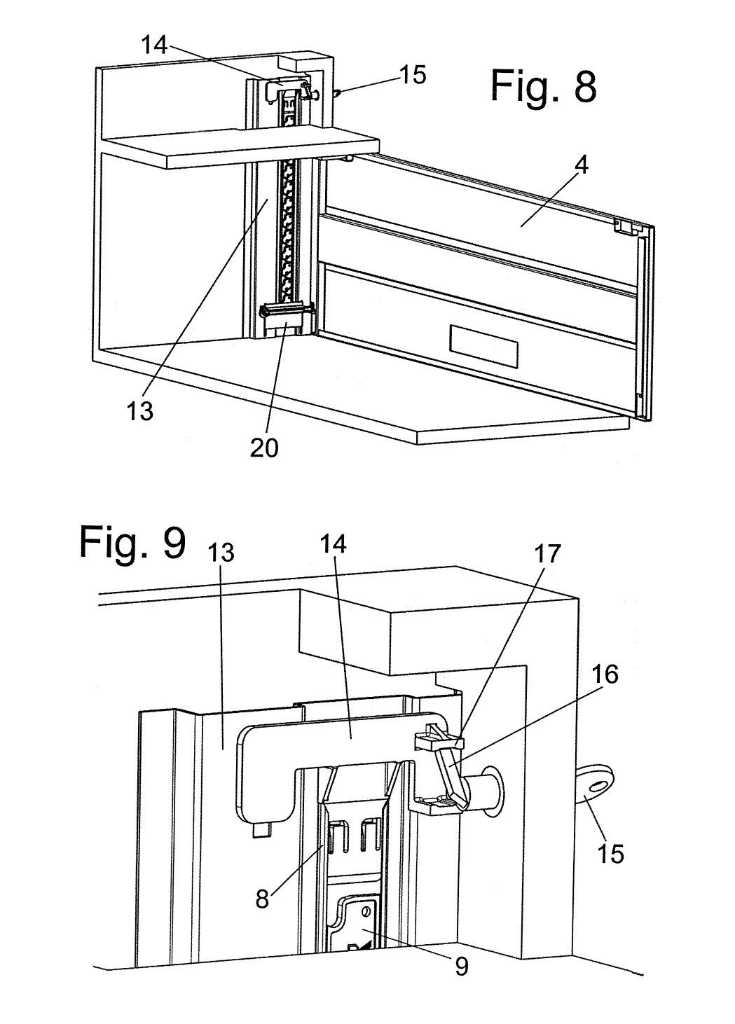

In FIG. 8, the piece of furniture 1 is illustrated with a closed and locked flap 4. For this purpose, the key 15 is rotated such that the yoke 14 is lifted over the bar element 16, which rests against the projection (see FIG. 9).

By displacing the yoke 14, the rail 8 with the blocking elements 9 is lifted, so that, in the area of the locking elements 20, a blocking element 9 has such an effect that each locking element 20 is displaced upwards. As a result, the hooks 21 on the locking element 20 move upwards and reach behind a web 25 on the flap 4. A recess 24 is provided on the web 25, in which recess 24 the hook 21 of a locking element 20 can be moved.

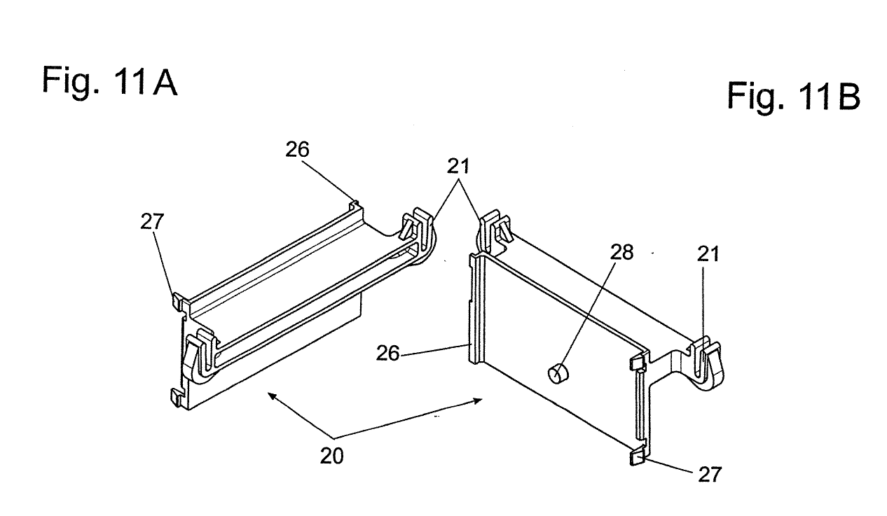

FIGS. 11A and 11B are detailed views of a locking element 20. The locking element 20 has a symmetrical construction with respect to a center plane, so that it can be used both for right and left sides of the piece of furniture 1. Since the locking element 20 includes a hook 21 at either end, one of the hooks 21 will not be used in operation. However, with this construction, manufacturing and storage costs for the locking elements 20 are saved because it is not necessary to make and store locking elements for both the right and left sides of the piece of furniture 1. Guiding ledges 26 and detent elements 27 are provided on the locking element 20 on opposite sides and are guided in the slots 23 of the holding rail 13. As a result of this construction, a locking element 20 may be locked in a simple manner on the holding rail 13. Furthermore, a pin-shaped driving device 28 is constructed on a plate of the locking element 20, which driving device 28 can be fitted into a receiving device 19 of a blocking element 9.

By operating the lock by way of the yoke 14, the rail 8, and the blocking elements 9 disposed therein, the locking element 20 is lifted by way of the driving device 28. Once the locking element 20 is lifted, a lateral hook 21 reaches behind and locks a web 25 or wall section of the flap 4. By lowering the above-mentioned elements by way of the key 15, the unlocked position is reestablished.

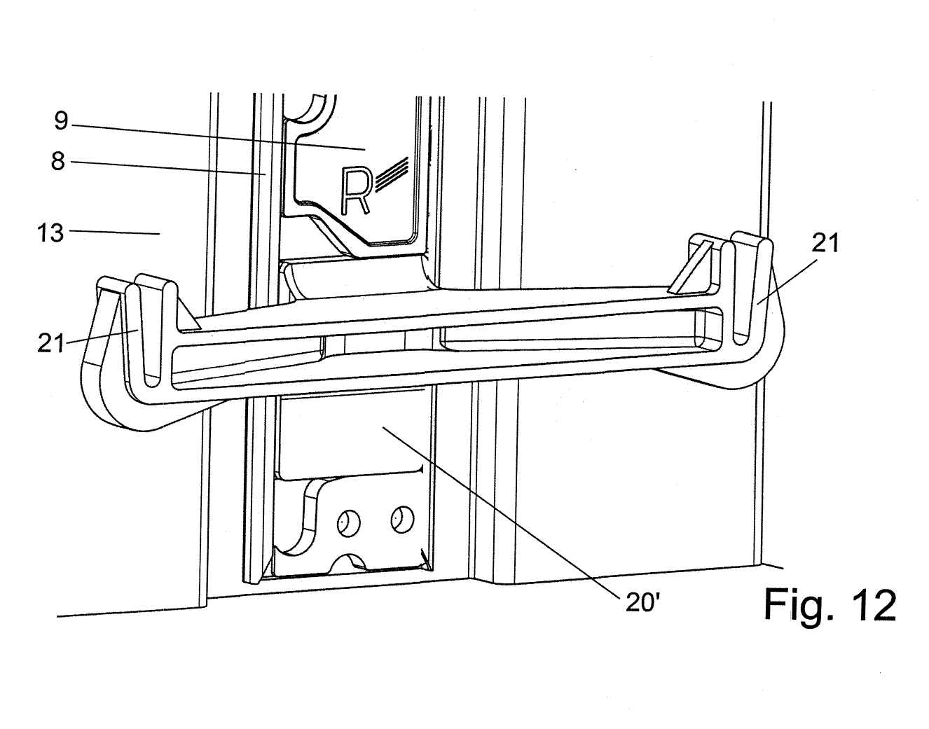

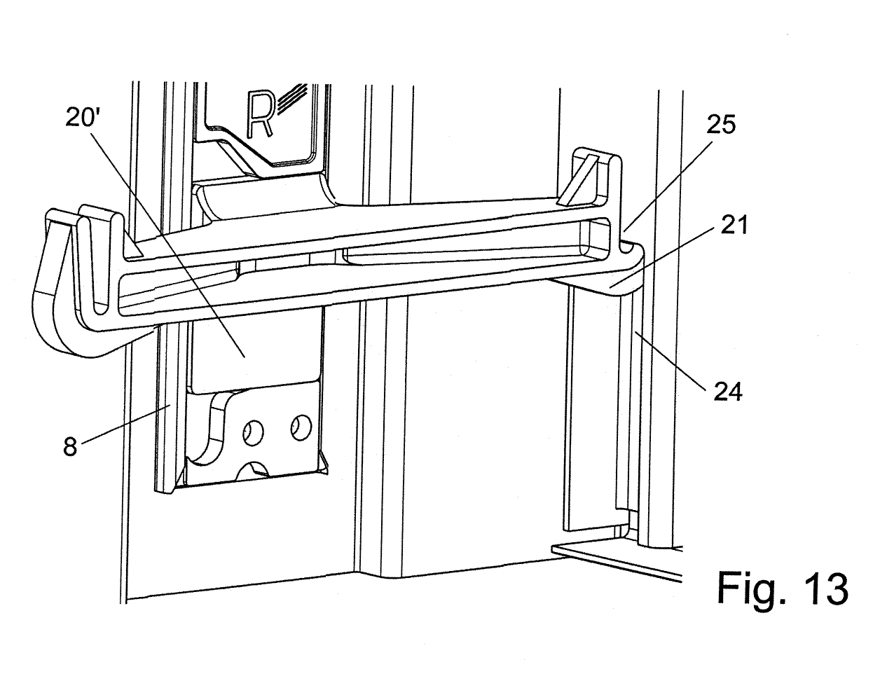

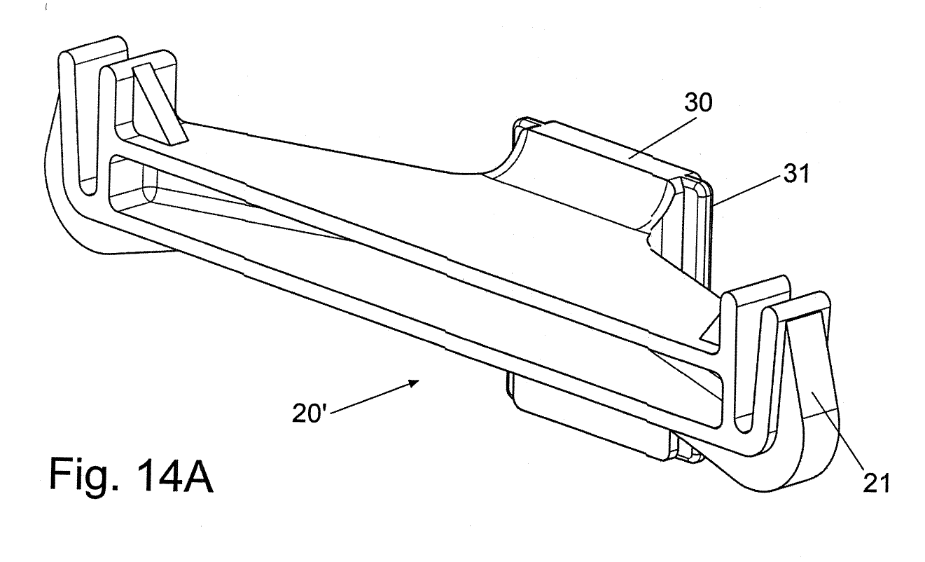

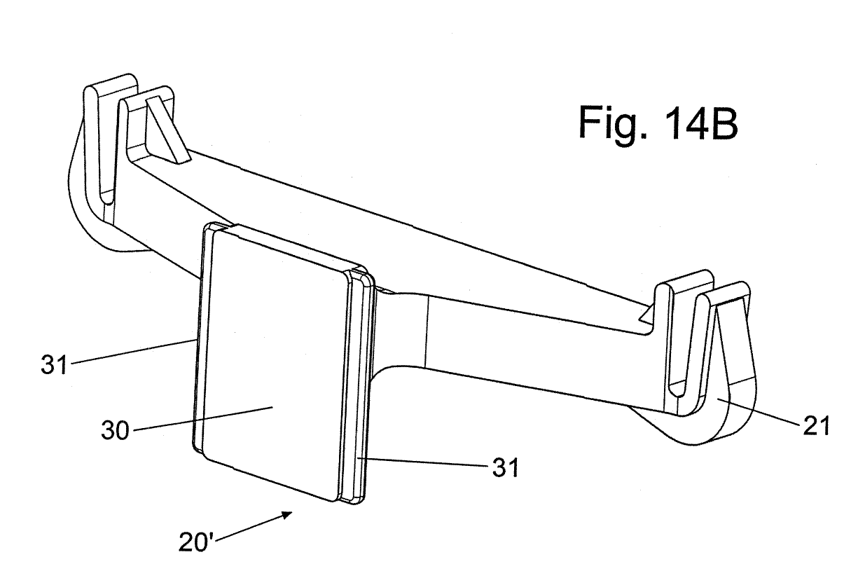

FIGS. 12 to 14B illustrate a modified embodiment of a locking element 20′, which is not only guided adjacent to the rail 8 and the blocking elements 9, but, by means of a plate, itself forms a blocking element 9 which is guided in the rail 8. The locking element 20′ has respective hooks 21 on opposite sides, which are constructed as in the preceding embodiment. By way of the hooks 21 a wall section 24 of the flap 4 can be locked.

The locking element 20′ has a plate 30 on which ledge-shaped projections 31 are provided on opposite sides. The projections 31 engage in lateral guides of the rail 8. As a result, the locking element 20′ is moved together with the blocking element 9.

In this embodiment of the blocking element 20′, it is possible to establish a locking of the flaps 4 by a lifting of the blocking elements 9 arranged above and below a spacer 10. The reason is that by disposing the locking elements 20′ in the rail 8, these are also lifted by the spacers 10 when a sliding element is pulled out. However, since the spacers 10 lift the blocking elements 9 only a slight distance, the flaps 4 may remain open. In this embodiment, locking may be effectuated only by a moving of the lock and a lifting of the yoke 14.

In the illustrated embodiment, the locking elements 20 and 20′ are equipped with hooks 21 in order to lock the flaps 4. Naturally, other locking devices in the form of lugs, pins, etc. are also conceivable and are intended to be encompassed by the present invention.

What is claimed is:

1. A piece of furniture, comprising:
a cabinet;
a plurality of sliding elements arranged above one another in the cabinet;
a plurality of swivellable flaps being positioned in front of the plurality of sliding elements;
at least one blocking rail disposed within the cabinet;
a plurality of locking elements associated with the at least one blocking rail;
a lock operably connected to the at least one blocking rail to move the at least one blocking rail, thereby moving the plurality of locking elements;
wherein each of the plurality of sliding elements are constructed and arranged to be pulled out of the cabinet only after an associated swivellable flap is opened, and
wherein the lock is constructed and arranged to operate on the at least one blocking rail and the plurality of locking elements to cause the plurality of locking elements to engage the plurality of swivellable flaps, thereby establishing a locked position, and to disengage from the plurality of swivellable flaps, thereby establishing an unlocked position.

2. The piece of furniture according to claim 1, wherein the lock operates on the blocking rail, the plurality of locking elements, the plurality of swivellable flaps, and the plurality of sliding elements to establish the locked and unlocked positions.

3. The piece of furniture according to claim 1, wherein, in the unlocked position, the plurality of swivellable flaps are openable and, when one of the plurality of sliding elements is pulled out, others of the plurality of sliding elements are blocked from being pulled out.

4. The piece of furniture according to claim 1, wherein the at least one blocking rail comprises two blocking rails, one on each side of the cabinet, and
wherein the plurality of locking elements include locking elements associated with each of the two blocking rails.

5. The piece of furniture according to claim 1, wherein the at least one blocking rail comprises a movable rail and a plurality of blocking elements displaceably disposed with respect to the rail.

6. The piece of furniture according to claim 5, further comprising:
a plurality of spacers associated with the plurality of sliding elements,
wherein the plurality of blocking elements are displaceable between two stops that define a predetermined path therebetween,
wherein, when one from the plurality of a sliding elements is pulled out, the associated spacer slides between two adjacent blocking elements, thereby preventing another of the plurality of spacers from a pushing apart the plurality of blocking elements positioned between the two stops.

7. The piece of furniture according to claim 1, wherein each of the plurality of locking elements defines at least one driving device that is coupled with one of the plurality of blocking elements.

8. The piece of furniture according to claim 1, wherein each of the plurality of locking elements comprises at least one hook shaped to engage a portion of one of the plurality of swivellable flaps for locking the flap.

9. The piece of furniture according to claim 1, characterized in that each of the plurality of locking elements is constructed to be symmetrical with respect to a center plane.

10. The piece of furniture according to claim 1, wherein each of the plurality of locking elements comprises guiding elements permitting movement parallel to the longitudinal direction of the associated blocking rail.

11. The piece of furniture according to claim 1, wherein the at least one blocking rail is disposed on a holding rail connected to the cabinet.

12. The piece of furniture according to one claim 1, wherein the plurality of swivelable flaps slide into the cabinet when in an opened, horizontal position.

13. The piece of furniture according to claim 1, further comprising:
a yoke connecting the at least one blocking rail with the lock,
wherein, by way of the yoke, the lock moves the at least one blocking rail from a lowered unlocked position into a lifted locked position.

14. The piece of furniture according to claim 5, further comprising:
a yoke connecting the at least one blocking rail with the lock,
wherein, by way of the yoke, the lock moves the moveable rail from a lowered unlocked position into a lifted locked position, and
wherein, by way of the yoke, the lock moves the moveable rail from a lifted locked position to a lowered unlocked position.

15. The piece of furniture according to claim 14, wherein, by way of the yoke, the lock moves both the moveable rail and the plurality of blocking elements displaceably disposed with respect thereto.
